(19) United States
(12) Patent Application Publication
(10) Pub. No.: US 2009/0053445 A1
(43) Pub. Date: Feb. 26, 2009

(54) PLASTIC BAGS AND ZIPPERS MANUFACTURED OF A POLYMERIC MATERIAL CONTAINING INORGANIC FILLER

(76) Inventors: John S. Trent, Franklin, WI (US); James C. Pawloski, Bay City, MI (US); Richard R. Dawkins, Saginaw, MI (US)

Correspondence Address: S.C. JOHNSON & SON, INC., 1525 HOWE STREET, RACINE, WI, 53403-2236, US

(21) Appl. No.: 11/844,421

(22) Filed: Aug. 24, 2007

(51) Int. Cl. C08K 3/04; B29D 22/00; C08K 3/26; C08K 3/36; C08L 23/06

(52) U.S. Cl. 428/36.92; 524/424; 524/436; 524/437; 524/443; 524/445; 524/448; 524/449; 524/451; 524/543; 524/80

(57) ABSTRACT

A polymeric substrate is disclosed that comprises a plastic matrix and an inorganic filler dispersed in the plastic matrix, wherein the polymeric substrate exhibits improved OTR and WVTR. The disclosed polymeric substrate may be used in manufacturing of plastic containers, such as plastic bags for containing food products. Preferably, the improved OTR and WVTR of the polymeric substrate contribute to better storage performance of the plastic bags, eg. keeping the food products within the plastic bags from degradation and/or dehydration

### BACKGROUND

1. Technical Field

A polymeric substrate comprising a plastic matrix and an inorganic filler, such as calcium carbonate, is disclosed. The disclosed polymeric substrate exhibits improved oxygen and water vapor transmission characteristics as compared to a polymeric substrate comprising the plastic matrix alone. In use, the polymeric substrate may be processed to manufacture food storage bags and/or closure elements thereof: Exemplary processes and equipments suitable for manufacturing the storage bags and closure elements comprising the disclosed polymeric substrate are also disclosed.

2. Description of the Related Art

Polymer compositions that comprise inorganic fillers are well known in the art. The inorganic filler may be calcium carbonate or other inorganic compounds and substances incorporated into polymeric materials for various improvements thereof The polymeric materials include a wide range of polyethylene materials including low-density polyethylene (LDPE), linear low-density polyethylene (LLDPE), or mixtures and blends thereof. Other suitable polymeric materials include other common Ziegler-Natta catalysts-based polyolefins such as high density polyethylene (HDPE), medium density polyethylene (MDPE), homopolymer polypropylene (HPP), random copolymer polypropylene (RCPP), and impact copolymer polypropylene (IMPP), as well as polyolefins manufactured using metallocene-based technology such as metallocene-LDPE, metallocene-LLDPE, metallocene-MDPE, metallocene-HDPE, metallocene-HPP, metallocene-RCPP, or mixtures and blends thereof. In addition, polymeric materials include ethylene vinyl acetate copolymers (EVA) and polyethylenevinylacetate (PEVA) that are products of LDPE technology and mixtures or blends thereof with common Ziegler-Natta and metallocene catalyst-based polyolefins

For example, a polymer film comprising film-forming polymer materials and large particles of an inert fillet material, wherein the inclusion of the filler material enables the controlling of the permeability of the polymer film, has been developed. The film-forming polymer materials include polyolefins such as LDPE and LLDPE, while the filler material is calcium carbonate. The polymer film generally comprises 85 wt % or more polymer and less than 8 wt % filler material. In order to achieve the desired permeability, the average particle size of the filler material ranges from 67% to 99% of the thickness of the polymer film.

Another known polymer film comprises 25-60 wt % filler, which may be an inorganic carbonate such as calcium carbonate or magnesium carbonate. In addition to the fillet, the polymer film may include a polymer such as LLDPE or PVA, and a metal carboxylate. The combination of the inorganic carbonate and metal carboxylate improves the thermal and chemical degradability of the polymers, thereby rendering the polymer film easier to decompose after disposal.

Another polymer film known in the art is provided as a decorative plastic sheet having intersecting tear lines thereon, wherein the plastic sheet is particularly suitable for covering surfaces such as those of shelf liners. The plastic sheet may comprise a polymeric material such as a polyolefin thermoplastic, and calcium carbonate dispersed therein One such plastic sheet comprises 85 wt % LDPE and 15 wt % calcium carbonate, wherein the average particle size of calcium carbonate is 12 microns

Some polymer films or sheets contain calcium carbonate as an anti-blocking agent which increases roughness on the surface of the films or sheets, thereby reducing the tendency of the films or sheets to stick to themselves or with each others. Examples of such polymer films include those made of LDPE or LLDPE, which may be used to make opaque or colored bags.

Because of the known benefit of incorporating calcium carbonate in a polyethylene film for enhancing the performance thereof, a wide variety of commercially available calcium carbonate-containing polyolefin pellets have been developed. Those pellets typically comprise 75-80 wt % calcium carbonate and 25-30 wt % polyolefin, such as LLDPE. In use, the calcium carbonate-containing pellets are blended with polyethylene and the mixture cast to form a polyethylene film. The replacement of a portion of polyethylene with calcium carbonate not only improves profitability and performance of the film, but also improves film barrier properties by reducing both oxygen transmission rate (OTR) and water vapor transmission rate (WVTR).

The use of polyethylene in manufacturing plastic bags and their closure elements are also well known in the art. In generally, such plastic bags and/or closure elements are made of LDPE alone or a blend of LDPE and LLDPE with LDPE being the primary component of the blend. The thickness of the plastic film used to make the polyethylene plastic bags varies according to the functions of the bags For example, the film thicknesses of a commercial sandwich bag, storage bag, and freezer bag are about 1.7 mil, 2.0 mil, and 2.7 mil, respectively.

When used as food containers, the polyethylene plastic bags are preferably transparent or translucent to enable a consumer to see through the side walls of the bag While it is generally preferable for the plastic bags to have a lower WVTR in order to keep the food from dehydration, the desirable OTR of the plastic film depends on the content of the bag. For example, fresh meat requires the presence of oxygen for maintaining color for consumer appeal, whereas cured meat typically degrades faster with increased oxygen exposure. Higher OTR also helps to maintain the freshness of vegetables within the plastic bag

Hence, there is a need for a polymeric substrate suitable for making plastic containers having desirable OTR and WVTR characteristics. Further, there is a need for a polymeric substrate that comprises an inorganic filler, wherein the inorganic filler improves the OTR and WVTR of the polymeric substrate without adversely affecting the mechanical characteristics of the polymeric substrate. Still further, there is a need for a plastic container that comprises a polymeric substrate comprising an inorganic filler to improve the cost efficiency as well as environmental friendliness of the container.

### SUMMARY OF THE DISCLOSURE

In satisfaction of the aforenoted needs, a polymeric substrate comprising a plastic matrix and an inorganic filler dispersed therein, wherein the polymeric substrate exhibits improved OTR and WVTR, is disclosed The disclosed polymeric substrate may be used to manufacture plastic containers, such as plastic bags for storing food products. Preferably, the improved OTR and WVTR of the polymeric substrate contribute to better storage performance of the plastic bags, e.g. keeping the food products from degradation and/or dehydration

The disclosed polymeric substrate may take a wide variety of shapes and forms. In one embodiment, the polymeric substrate is a thin film that forms at least a portion of a plastic bag. The film may be opaque or translucent. In another embodiment, the polymeric substrate is a pair of interlocking strips that form a closure element around the opening of the plastic bag. The polymeric substrate may further comprise a dye or pigment depending on the form and utility of the substrate.

When used in the manufacturing of plastic bags, the plastic matrix of the polymeric substrate may comprise a thermoplastic material, such as LDPE, LLDPE, or mixtures and blends thereof. Suitable thermoplastic material for use in a particular bag generally depends on the cost and availability of the plastic material and the utility of the bag.

The inorganic filler suitable for use in the disclosed polymeric substrate may be a readily available and relatively inexpensive inorganic substance that is chemically compatible with the plastic material, i.e., does not substantially change the chemical composition of the plastic material. In one embodiment, the inorganic filler is calcium carbonate.

The inorganic filler is preferably dispersed evenly in the plastic matrix, such as by blending small particles of the inorganic filler into a melted stream of the plastics material The particle size of the inorganic filler may affect the mechanical properties and performance of the polymeric substrate, as well as OTR and WVTR thereof.

The average particle size of the inorganic filler suitable for use in the disclosed polymeric substrate is preferably no more than 10 microns, more preferably no more than 5 microns, and most preferably no more than 3 microns.

According to one aspect of this disclosure, the inorganic filler is included in the polymeric substrate as a replacement of the thermoplastic material which not only requires more natural resources and energy to manufacture, but also poses more risks to the environment after disposal because of its low degradability. As a result, a more cost effective and environmentally friendly plastic bag can be obtained.

Further, the inclusion of the inorganic filler in the polymeric substrate improves OTR and WVTR of the disclosed polymeric substrate In one embodiment, the polymeric substrate containing calcium carbonate as the inorganic filler exhibits an increased OTR than a control substrate that is made of the plastic matrix without the presence of the inorganic fillet, which is unexpected according to the general knowledge in the field of this disclosure

When used in a plastic food container, the increased OTR improves the storage performance of the plastic container by keeping certain food products within the disclosed container fresher than a conventional container made of the plastic matrix without the presence of the inorganic filler The inorganic filler also functions to decrease WVTR of the container thereby preventing the food products therein from dehydration.

A zippered plastic bag manufactured by using the polymeric substrate is also disclosed. In one embodiment, the zippered bag comprises a front wall made of a conventional thermoplastic material, and a back wall made of the disclosed polymeric substrate The front wall is preferably transparent or translucent so that the contents of the plastic bag can be seen by a consumer.

In another embodiment, the zippered bag comprises a front wall made primarily of the polymeric substrate but with the provision of a window thereon, wherein the window is made of a conventional plastic material that is preferably transparent or translucent. In such an embodiment, a relatively large portion of the plastic bag is made of the disclosed polymeric substrate.

The zipper of the plastic bag may also be manufactured from the disclosed polymeric substrate. In one embodiment, the zipper is a pair of interlocking strips of the disclosed polymeric substrate formed around the opening of the plastic bag for multiple opening and closing applications. The polymeric substrate used to form the zipper may further comprise a dye or pigment.

Methods and apparatuses for manufacturing the disclosed polymeric substrates and plastic bags are also disclosed. In one embodiment, the zippered plastic bag is manufactured by casting a blend of the thermoplastic material and inorganic filler to form a plastic film. After, the plastic film is cooled, a female zipper strip and a male zipper strip are extruded on the outer edges of the film, respectively. Thereafter, the film is folded in the middle and heat sealed to form the zippered bag.

The inclusion of the inorganic filler in the disclosed zippered bag preferably improves the OTR and/or WVTR thereof. In one embodiment, the presence of the inorganic filler in the zippered bag not only increases the OTR of the substrate, but also decreases the WVTR of same.

The inclusion of the inorganic fillet in the disclosed zippered bag preferably does not adversely affect the mechanical strength and performance of the polymeric substrate. In one embodiment, the zippered bag exhibit substantially similar, or in some cases improved, mechanical characteristics.

Other advantages and features of the disclosed polymeric substrates and zippered plastic bags, as well as the manufacturing method thereof, will be described in greater detail below. Although only a limited number of embodiments are disclosed herein, different variations will be apparent to those of ordinary skill in the art and should be considered within the scope of this disclosure.

### BRIEF DESCRIPTION OF THE DRAWINGS

For a more complete understanding of the disclosed polymeric substrate, and methods and apparatuses for manufacturing thereof; reference should be made to the embodiments illustrated in greater detail in the accompanying drawings, wherein:

FIG. 1 is a perspective view of a strip of film made of the polymeric substrate in accordance with this disclosure;

FIG. 2 is a back perspective view of the zippered plastic bag comprising the disclosed polymeric substrate;

FIG. 3 is a front perspective view of another zippered plastic bag comprising the disclosed polymeric substrate particularly showing the front window configuration of the bag;

FIG. 4 is an enlarged side sectional view of the zipper and its closing mechanism for sealing the zippered plastic bag illustrated in FIGS. 2-3;

FIG. 5 is a graphic illustration of a film suitable for forming the plastic bag illustrated in FIG. 2 and a segmented die for casting the film;

FIG. 6 is a graphic illustration of a manufacturing process for casting the film illustrated in FIG. 5;

FIG. 7 is a graphic illustration of the film illustrated in FIG. 5, further incorporating a zipper for sealing and opening the plastic bag;

FIG. 8 is a graphic illustration of a manufacturing process for extruding the zipper illustrated in FIG. 7 and applying the zipper on the film;

FIG. 9 is a graphic illustration of a manufacturing process for folding and sealing the film with the zipper thereon to form the zippered plastic bag illustrated in FIG. 2;

FIG. 10 is a graphic illustration of the effect of filler concentration on the Drop Impact Energy of a film made of the disclosed polymeric substrate;

FIG. 11 is a graphic illustration of the effect of filler concentration on the Ultimate Tensile Strength of a film made of the disclosed polymeric substrate; and

FIG. 12 is a graphic illustration of the effect of filler concentration on the Ultimate Elongation at Break of a film made of the disclosed polymeric substrate.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION OF THE PRESENTLY PREFERRED EMBODIMENTS

In general, this disclosure is directed toward a polymeric substrate comprising a plastic matrix and an inorganic filler dispersed therein, wherein the polymeric substrate exhibits improved OTR and WVTR comparing to a polymeric substrate comprising the plastic matrix alone. When the disclosed polymeric substrate is used to manufacture plastic containers, such as zippered plastic bags for containing food products, the improved OTR and WVTR of the polymeric substrate preferably improve the storage performance of the plastic bags, eg. keeping certain food products flesh.

Moreover, the replacement of at least a portion of the plastic material with the inorganic filler not only improves the oxygen and water vapor transmission characteristics of the disclosed polymeric substrate, but also reduces the disposal of environmentally harmful plastic materials. Further, as the inorganic filler is naturally abundant and readily recyclable, it functions as an economical and environmentally friendly replacement or additive to the plastic matrix.

In a general embodiment, the disclosed polymeric substrate comprises from about 55 to about 99 wt % plastic matrix, from about 1 to about 40 wt % inorganic filler, and optional ingredients such as pigments, stabilizers, plasticizers, modifiers etc. Preferably, the inclusion of the inorganic filler improves the OTR and WVTR of the polymeric substrate without adversely affecting the mechanical strength and performance thereof.

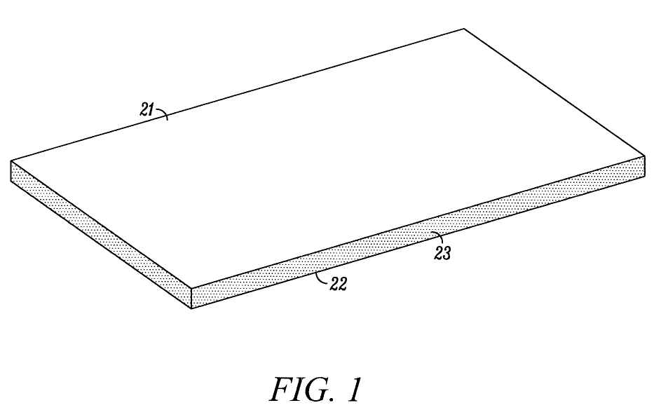

In one embodiment, as illustrated in FIG. 1, the polymeric substrate 21 may be processed into a thin film, wherein the substrate 21 comprises the plastic matrix 22 and small particles of the inorganic filler 23 dispersed or impregnated in the plastic matrix 22. The film may be opaque or translucent, depending on factors such as the thickness of the film, the nature of the plastic matrix, as well as the type, concentration, and particle size of the inorganic fillet dispersed in the plastic matrix In use, the film may be used to form at least a portion of a plastic container, such as a zippered plastic bag for storage of food products.

The plastic matrix of the disclosed polymeric substrate may include any conventional thermoplastic material. When the polymeric substrate is used in plastic bags, the thermoplastic material suitable for the plastic matrix generally depends on the cost and availability of the thermoplastic material, as well as the utility of the bag.

The thermoplastic material may be of any suitable type apparent to one of ordinary skill in the art including, but not limited to, homopolymers, copolymers, block polymers, graft polymers, etc. With respect to spatial configurations, the thermoplastic material may be linear and branched, and may include all possible geometrical configurations such as isotactic, syndiotactic and atactic configurations.

One suitable class of thermoplastic materials for use in the disclosed polymeric substrate is polyolefin, which may include homopolymers and copolymers of ethylene and linear or branched olefins having at least three, preferably three to ten, carbon atoms, as well as mixtures, grafts, and blends thereof Examples of the homopolymeric polyolefin which may be used in the disclosed polymeric substrate are polyethylene, polypropylene, poly(1-butene), and the like. Representative examples of suitable copolymeric polyolefin include ethylene/propylene, ethylene/butene, ethylene/pentene, ethylene/hexene, ethylene/heptene and ethylene/octene copolymers.

Examples of other thermoplastic materials which can be used in the disclosed polymeric substrate include polyesters, polyamides, polystyrene, vinyl polymers, polyalkylene oxide, polycarbonate, as well as mixtures, copolymers, grafts and blends thereof. Suitable polyesters include polyethylene terephtalate and polybutene terephtalate The polyamides may be various types of nylon known in the art. The vinyl polymers may be polyvinyl chloride, polyvinyl acetate, ethylene vinyl-acetate copolymers and ethylene-vinyl alcohol copolymers.

In one embodiment, the plastic matrix of the polymeric substrate comprises polyethylene suitable for use in plastic films, such as medium density polyethylene (MDPE), LDPE, LLDPE, very low density polyethylene (VLDPE), or mixtures thereof. In a particular refinement, the disclosed polymeric substrate comprises from about 30 to about 99 wt % LDPE and from about 0 to about 40 wt % LLDPE. It is to be understood that the amount of the LDPE and LLDPE suitable for inclusion in the polymeric substrate would be apparent to those of ordinary skill in the art and should not be considered as limiting the scope of this disclosure.

The inorganic filler suitable for use in the disclosed polymeric substrate may be a readily available and relatively inexpensive inorganic substance that is chemically compatible with the plastic material, i e does not substantially change the chemical composition of the plastic material.

In one embodiment, the inorganic filler is selected from the group consisting of inorganic carbonates, synthetic carbonates, nepheline syenite, talc, magnesium hydroxide, aluminum trihydrate, diatomaceous earth, mica, natural or synthetic silicas, calcined clays, and mixtures thereof.

Preferably, the inorganic filler is an inorganic carbonate such as calcium carbonate or magnesium carbonate. However, other metal carbonates or bicarbonates such as lithium carbonate, sodium carbonate or sodium bicarbonate may also be used. In addition, the synthetic carbonates such as the hydrotalcite-like compound or the dihydroxyaluminium sodium carbonates may be used in the present invention. In one embodiment, the inorganic filler is calcium carbonate.

According to one aspect of this disclosure, the polymeric substrate may include from about 1 to about 40 wt %, more preferably from about 10 to about 30 wt %, inorganic filler. In one embodiment, about 20 wt % inorganic filler is included in the polymeric substrate. It is to be understood, of course, that the type and quantity of the inorganic filler suitable for inclusion in the polymeric substrate would be apparent to one of ordinary skill in the art without undue experimentation and therefore should be considered as within the scope of this disclosure.

Preferably, the inorganic filler is dispersed evenly in the plastic matrix, such as by blending small particles of the inorganic filler into a melted stream of the thermoplastic material. In one embodiment, the inorganic filler is provided as calcium carbonate master batch containing 20 wt % LLDPE and 80 wt % calcium carbonate, sold under the trade name HM10®MAX by Heritage Plastics (1002 Hunt St., Picayune, Miss. 39466). In another embodiment, the inorganic filler is provided as a calcium carbonate masterbatch containing 40 wt % LDPE and 60 wt % calcium carbonate. The inorganic filler may also be provided as finely ground particles of bulk calcium carbonate. When calcium carbonate masterbatch is used in the polymeric substrate, the concentration of the inorganic filler in the disclosed formulation should be adjusted to exclude any polymeric material in the masterbatch

The particle size of the inorganic fillet may affect the mechanical properties and performance of the polymeric substrate, as well as OTR and WVTR thereof. In one embodiment, the average particle size of the inorganic filler suitable for use in the disclosed polymeric substrate is preferably no more than 10 microns, more preferably no more than 5 microns, and most preferably no more than 3 microns. In one embodiment, the average particle size of the inorganic fillet is about 2 microns In another embodiment, the average particle size is about 0.7 micron.

The polymeric substrate according to this disclosure may further optionally comprise additives to impart or enhance certain properties of the substrate. Suitable optional additives include, but are not limited to, pigments, antioxidants, stabilizers, antifogging agents, plasticizers, waxes, flow promoters, surfactants, materials added to enhance the processability of the composition, and the like These additives preferably do not adversely affect the chemically composition, OTR/WVTR, and mechanical strength of the polymeric substrate. The optional additives may be incorporated in the polymeric substrate by conventional blending techniques generally known to one of ordinary skill in the art without undue experimentation.

In use, the disclosed polymeric substrate may be processed to form a plastic container, such as a bag, a wrap, a pouch, a box, or portions thereof. In one embodiment, the polymeric substrate forms a portion of a plastic bag. The plastic bag may include, for example, zipper bags or bags with other interlocking closures, open-mouth bags, food-storage bags, household storage bags, freezer bags, sandwich bags, trash bags etc.

When the polymeric substrate is used as a film to form the bags, the thickness of the film typically depends on the application of the bag. For example, a sandwich bag may have a film thickness of about 1.7 mils; a storage bag may have a film thickness of about 2.0 mils; and a freezer bag may have a film thickness of about 2.7 mils. It is to be understood that one of ordinary skill in the art would be able to determine the appropriate shape and dimension of the substrate according to its application without undue experimentation

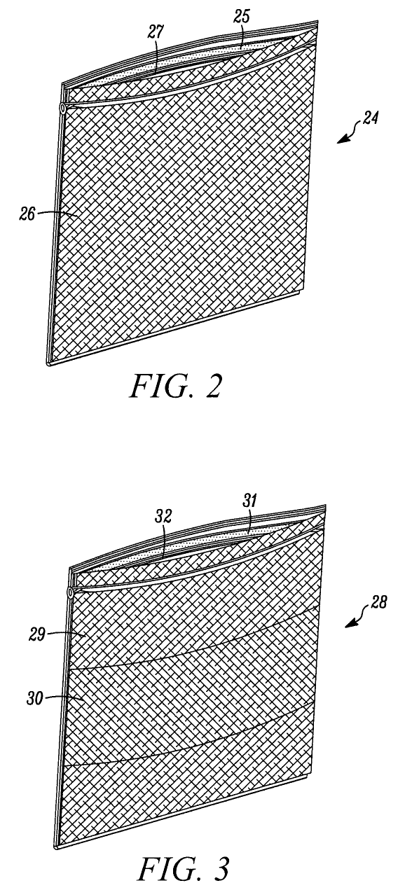

In one embodiment, as illustrated in FIG. 2, the zippered bag 24 comprises a front wall 25 made of a conventional plastic material, a back wall 26, and a zipper 27, both made of the disclosed polymeric substrate. While the back wall 26 may be opaque or translucent, the front wall 25 is preferably transparent or translucent so that the contents of the zippered bag 24 can be observed by a consumer.

In another embodiment, as illustrated in FIG. 3, the zippered bag 28 comprises a front wall 29 made primarily of the polymeric substrate but with the provision of a window 30 thereon, wherein the window 30 is made of a conventional plastic material that is preferably transparent or translucent. The zippered bag 28 further comprises a back wall 31 and a zipper 32, both made of the polymeric substrate. Comparing with the bag illustrated in FIG. 2, the bag illustrated in FIG. 3 has a relatively larger portion made of the disclosed polymeric substrate.

A non-limiting exemplary formulation for the polymeric substrate suitable for use in the zippered bag is listed below:

| Weight Percent | Chemical Name | Function |
|---|---|---|
| 30-99 | LDPE | Plastic Matrix |
| 0-40 | LLDPE | Plastic Matrix |
| 1-40 | Calcium Carbonate | Inorganic Filler |

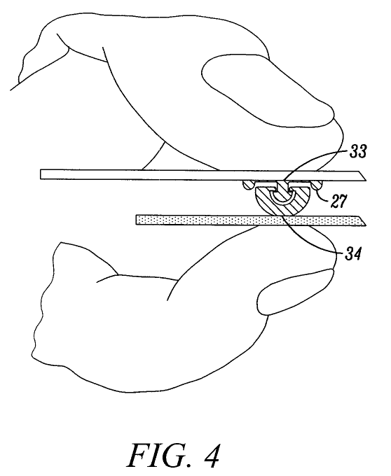

Turning to FIG. 4, which illustrates an enlarged side sectional view of the zipper 27, which may be manufactured from the disclosed polymeric substrate In those embodiments, the zipper 27 is a pair of interlocking strips formed around the opening of the plastic bags for multiple opening and closing applications As illustrated in FIG. 4, the interlocking strips included a male strip 33 permanently attached to one side of the polymer substrate of FIG. 2 near the opening, and a female strip 34 permanently attached to the other side of the polymer substrate of FIG. 2 and detachably connected with the male strip 33. The polymeric substrate used to form the zipper 37 may further comprise a dye or pigment for aesthetic and/or identification purposes.

A non-limiting exemplary formulation for the polymeric substrate suitable for use in the zippered bag is listed below:

| Weight Percent | Chemical Name | Function |
|---|---|---|
| 30-99 | LDPE | Plastic Matrix |
| 0-40 | LLDPE | Plastic Matrix |
| 1-40 | Calcium Carbonate | Inorganic Filler |
| 0-5 | Pigment | Colorant |

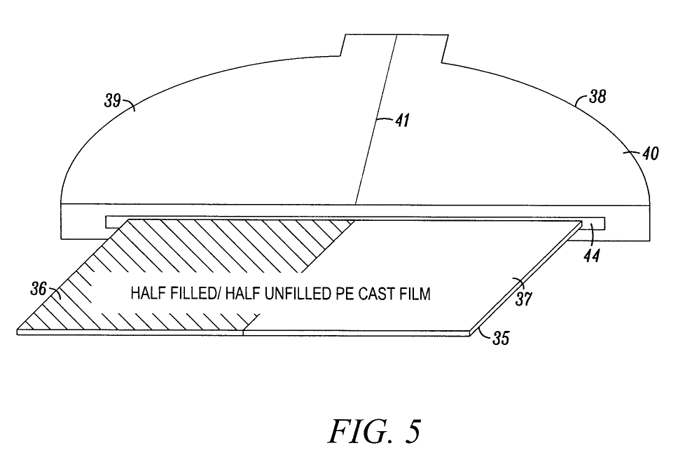

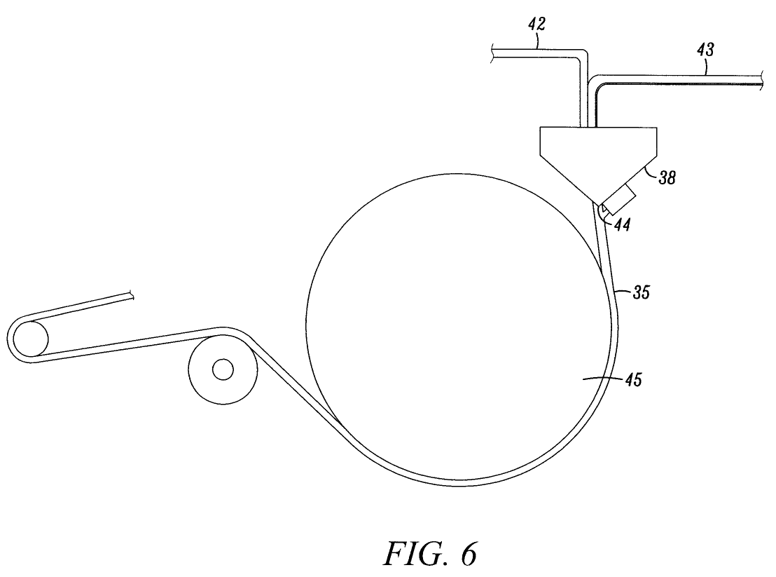

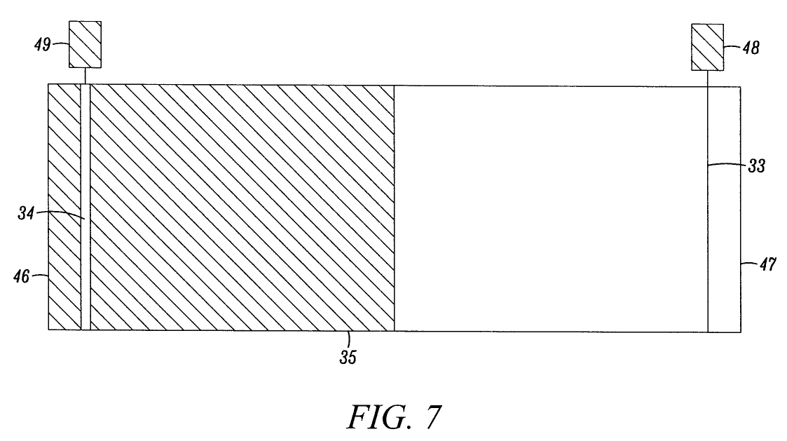

Exemplary methods and apparatuses for manufacturing the disclosed polymeric substrate, plastic bag, and zipper are illustrated in FIGS. 5-10. It is to be understood that the disclosed methods and apparatuses are for illustration purposes only and are not intended to limit the scope of this disclosure. FIGS. 5-6 illustrate a plastic film 35 suitable for forming the plastic bag 24 illustrated in FIG. 2 and the manufacturing process thereof The plastic film 35 comprises a filled half 36 made of the disclosed polymeric substrate and an unfilled half 37 made of a conventional polyether material

In the embodiment of FIGS. 5-10 the plastic film 35 is cast from a segmented die 38 comprising two compartments 39 and 40 and a segmenting wall 41 dividing the two compartments. In operation, a melt stream of the thermoplastic material and calcium carbonate is fed into compartment 39 through an inlet 42; and a melt stream of the thermoplastic material without calcium carbonate is fed into compartment 40 through an inlet 43. The plastic film 35 is cast through an elongated casting slit 44 and cooled on a chill roll 45 Because the casting slit 44 is undivided, the cast film 35 retains a one-piece structure while comprising two halves of different composition.

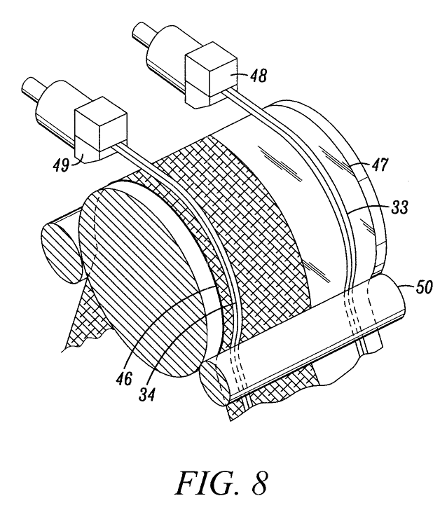

After the cast film 35 is cooled to a suitable temperature, the zipper 27 is extruded and applied close to the left and right edges 46 and 47 of the cast film 35. As illustrated in FIGS. 7-8, the male strip 33 is extruded from a male profile extruder 48 close to the light edge 47; and the female strip 34 is extruded from female profile extruder 49 close to the left edge 46. Both strips 33 and 34 are applied on the corresponding edges 46 and 47 of the cast film 35 through an application roller 50.

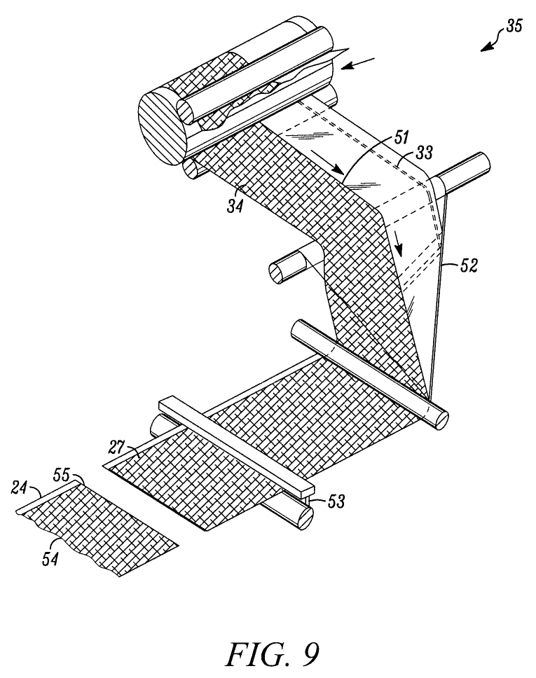

In order to form the plastic bag 24 illustrated in FIG. 2, the cast film 35 with the zipper 27 applied thereon is folded through a center line 51 by passing through a folding bar 52, as illustrated in FIG. 9. This folding process also functions to align the male strip 33 with the female strip 34 of the zipper 27. The folded film 35 and the zipper 27 then passes through a cutting and sealing device 53, where the continuous film 35 is cut into segments of predetermined dimension and heat sealed along the side edges 54 and 55 to form the plastic bag 24 illustrated in FIG. 2.

Some exemplary formulations of the disclosed plastic films and zipper are listed below.

| | | |
|---|---|---|
| Weight Percent | Chemical Name | Function |

Substrate I (Film Composition)

| | | |
|---|---|---|
| 70 | LDPE | Plastic Matrix |
| 26 | LLDPE | Plastic Matrix |
| 4 | Calcium Carbonate | Inorganic Filler |

Substrate II (Film Composition)

| | | |
|---|---|---|
| 65 | LDPE | Plastic Matrix |
| 27 | LLDPE | Plastic Matrix |
| 8 | Calcium Carbonate | Inorganic Filler |

Substrate III (Film Composition)

| | | |
|---|---|---|
| 60 | LDPE | Plastic Matrix |
| 28 | LLDPE | Plastic Matrix |
| 12 | Calcium Carbonate | Inorganic Filler |

Substrate IV (Film Composition)

| | | |
|---|---|---|
| 55 | LDPE | Plastic Matrix |
| 29 | LLDPE | Plastic Matrix |
| 16 | Calcium Carbonate | Inorganic Filler |

Substrate V (Zipper Composition)

| | | |
|---|---|---|
| 92 | LDPE | Plastic Matrix |
| 1 | LLDPE | Plastic Matrix |
| 4 | Calcium Carbonate | Inorganic Filler |
| 3 | Pigment | Colorant |

Substrate VI (Zipper Composition)

| | | |
|---|---|---|
| 87 | LDPE | Plastic Matrix |
| 2 | LLDPE | Plastic Matrix |
| 8 | Calcium Carbonate | Inorganic Filler |
| 3 | Pigment | Colorant |

Substrate VII (Zipper Composition)

| | | |
|---|---|---|
| 82 | LDPE | Plastic Matrix |
| 3 | LLDPE | Plastic Matrix |
| 12 | Calcium Carbonate | Inorganic Filler |
| 3 | Pigment | Colorant |

Substrate VIII (Zipper Formulation)

| | | |
|---|---|---|
| 77 | LDPE | Plastic Matrix |
| 4 | LLDPE | Plastic Matrix |
| 16 | Calcium Carbonate | Inorganic Filler |
| 3 | Pigment | Colorant |

When the disclosed zippered bags are purported for storing food products, the plastic film of the bag preferably has desirable banner characteristics, such as OTR and WVTR, to help maintain the freshness of the food products.

OTR is the measurement of the amount of oxygen gas that passes through a substance over a given period It is mostly carried out on non-porous materials, where the mode of transport is diffusion. Generally, OTR is measured according to the following two standard tests: 1) ASTM D3985-05 “Standard Test Method for Oxygen Gas Transmission Rate Through Plastic Film and Sheeting Using a Coulometric Sensor”; and 2) ASIM F1307-02(2007) “Standard Test Method for Oxygen Transmission Rate Through Dry Packages Using a Coulometric Sensor.” OTR is typically measured in cc-mil/100 square inch/day.

WVTR generally refers to the quantity of the steam amount under provided temperature and humidity conditions, which passes through unit area of film materials in fixed time. In this disclosure, WVTR is typically measured by either ASTM E96-95 “Standard Test Methods for Water Vapor Transmission of Materials” or ASTM D895-94 “Standard Test Method for Water Vapor Permeability of Packages”. The unit of WVTR in this disclosure is g-mil/100 square inch/day.

As discussed above, both fresh meat and vegetable benefit from an increased OTR and a decreased WVTR of their container Moreover, while the inclusion of an inorganic filler in a polymeric substrate generally decreases the WVTR thereof, the filler-containing substrate generally exhibits a decreased OTR as well. According to one aspect of this disclosure, however, the inclusion of the inorganic filler in the disclosed polymeric substrate increases OTR of the disclosed polymeric substrate while decrease the WVTR of same, which is unexpected according to the general knowledge in the field of this disclosure.

The comparison between the OTR of the disclosed polymeric substrates (Substrates II-IV above) and a Control Substrate comprising 75 wt % LDPE and 25 LLDPE is listed in Table 1 below.

TABLE 1
Oxygen Transmission Rate of the Polymeric Substrate

| Substrate | CaCO₃ Concentration | OTR (cc-mil/100 in.²/day) |
|---|---|---|
| Control | 0 wt % | 300 |
| II | 8 wt % | 420 |
| III | 12 wt % | 440 |
| IV | 16 wt % | 415 |

Table 1 demonstrates that the presence of calcium carbonate significantly increases the OTR of the polymeric substrate. In one embodiment, the inclusion of calcium carbonate increases OTR of the substrate by at least 10%, more preferably by at least 20%, and most preferably by at least 30%, when compared to the Control Substrate comprising no calcium carbonate.

The comparison between the WVTR of the disclosed polymeric substrates (Substrates II-IV above) and the Control Substrate comprising 75 wt % LDPE and 25 LLDPE is listed in Table 2 below.

TABLE 2
Water Vapor Transmission Rate of the Polymeric Substrate

| Substrate | CaCO₃ Concentration | WVTR (g-mil/100 in.²/day) |
|---|---|---|
| Control | 0 wt % | 1.25 |
| II | 8 wt % | 0.72 |
| III | 12 wt % | 0.72 |
| IV | 16 wt % | 0.72 |

It is clearly demonstrated in Table 2 that the presence of calcium carbonate significantly decreases the WVTR of the polymeric substrate. In one embodiment, the inclusion of calcium carbonate decreases WVTR of the substrate by at least 20%, more preferably by at least 30%, and most preferably by at least 40%, when compared to the Control Substrate comprising no calcium carbonate.

As discussed above, the inclusion of the inorganic filler in the disclosed polymeric substrate improves the barrier characteristics, such as OTR and WVTR thereof. In one embodiment, the presence of the inorganic filler in the polymeric substrate not only increases the OTR of the substrate, but also decreases the WVTR of same. When used in a plastic food container, the increased OTR improves the storage performance of the plastic container by keeping certain food products within the disclosed container fresher than a conventional container made of the plastic material without the addition of the inorganic filler. The inorganic filler also functions to decrease WVTR of the container thereby preventing the food product therein from dehydration.

The replacement of a portion of the plastic material with the inorganic filler preferably does not adversely affect the mechanical strength and performance of the polymeric substrate, particularly when the substrate is used to form a food container. In one embodiment, the disclosed plastic bag exhibits substantially similar, or in some cases improved, mechanical characteristics, such as Drop Dart Impact Energy, Ultimate Tensile Strength, Ultimate Elongation at Break, etc.

Drop Dart Impact Energy (DDIE) is the energy that causes plastic film to fail under the impact of a free-falling dart. This energy is expressed in terms of the weight of the dart falling from a specified height which would result in 50% failure of the specimens tested. DDIE in this disclosure is measured in ft-lbs.

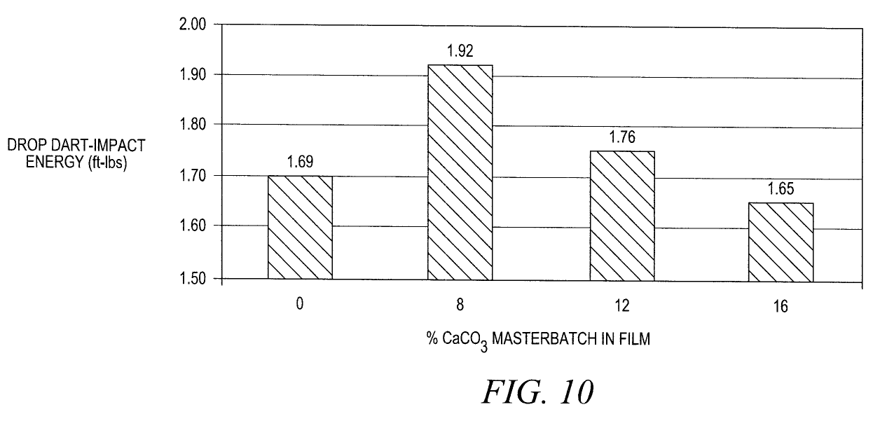

Referring to FIG. 10, which graphically illustrates the comparison between DDIEs of the disclosed polymeric substrates (Substrate II-IV) and the Control Substrate containing no inorganic filler. The inclusion of the inorganic filler either substantially maintains the DDIE of the substrate, as in Substrate IV, or significantly increases the DDIE of the substrate, as in Substrate II and III.

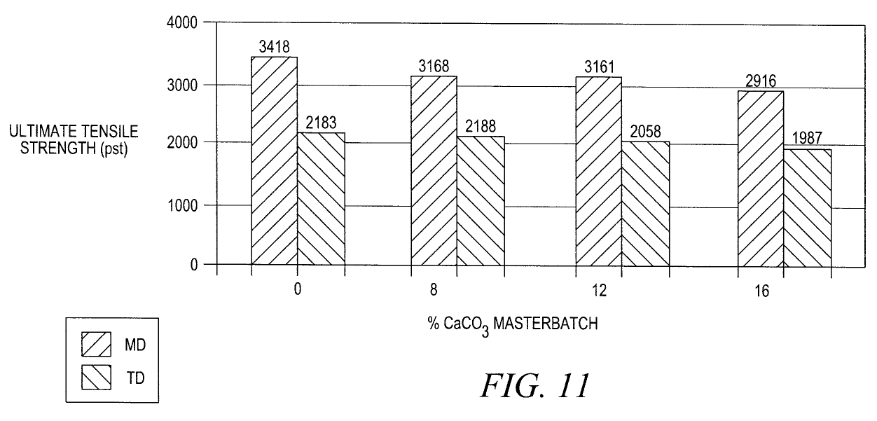

Ultimate Tensile Strength (UTS) of a material is the maximum amount of tensile stress that it can be subjected to before failure, measured in pounds per square inch (psi). The UTS of a sample is measured both in machine direction (MD), in which the tensile stress is applied in the same direction as the direction of the sample being cast, and in transverse direction (TD), in which the tensile stress is applied in the direction that is perpendicular to MD. Referring to FIG. 11, which graphically illustrates the comparison between the UTSs of the disclosed polymeric substrates (Substrate II-IV) and the Control Substrate containing no inorganic filler. In all cases, the inclusion of the inorganic filler substantially maintains the UTS of the substrate.

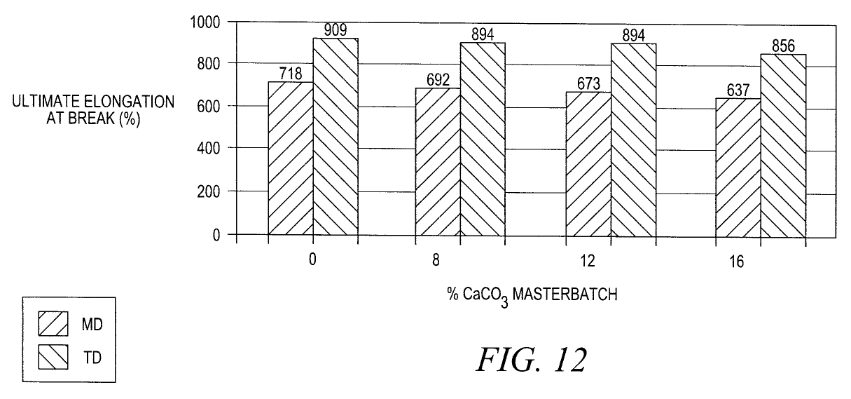

Ultimate Elongation at Break (UEB) is the percentage of the original length recorded at the moment of rupture of a material It generally corresponds to the breaking or maximum load. Like the UTS discussed above, UEB is measured both in MD and ID. A comparison between the UEBs of the disclosed polymeric substrates (Substrate II-IV) and the Control Substrate containing no inorganic filler is illustrated in FIG. 12 Like the UIS test, the inclusion of the inorganic filler substantially maintains the UEB of the substrate in all cases

When the disclosed polymeric substrate is used to form the closure element, such as the zipper, it is preferable that the replacement of a portion of the plastic material with the inorganic filler preferably does not adversely affect the mechanical strength and performance of the closure element as well.

While only certain embodiments have been set forth, alternatives and modifications will be apparent from the above description to those skilled in the art. These and other alternatives are considered equivalents and within the spirit and scope of this disclosure and the appended claims.

What is claimed:

1. A polymeric substrate comprising:
from about 55 to about 99 wt % of a plastic matrix comprising a thermoplastic material;
from about 1 to about 40 wt % of an inorganic filler dispersed in the plastic matrix; and
from about 0 to about 5 wt % of a pigment,
wherein the inclusion of the inorganic filler increases the oxygen transmission rate of the polymeric substrate

2. The substrate of claim 1 wherein the thermoplastic material is low-density polyethylene.

3. The substrate of claim 1 wherein the thermoplastic material is a mixture of low-density polyethylene and linear low-density polyethylene.

4. The substrate of claim 3 wherein the concentration of the linear low-density polyethylene is lower than the concentration of the low-density polyethylene in the substrate.

5. The substrate of claim 1 wherein the inorganic filler is selected from the group consisting of inorganic carbonates, synthetic carbonates, nepheline syenite, talc, magnesium hydroxide, aluminum trihydrate, diatomaceous earth, mica, natural or synthetic silicas, calcined clays, and mixtures thereof.

6. The substrate of claim 5 wherein the inorganic filler is calcium carbonate.

7. The substrate of claim 1 wherein the inclusion of the inorganic filler decreases the water vapor transmission rate of the substrate.

8. The substrate of claim 1 wherein the inclusion of the inorganic filler increases the oxygen transmission rate of the substrate by at least about 10%.

9. The substrate of claim 1 wherein the inclusion of the inorganic filler decreases the water vapor transmission rate of the substrate by at least about 20%.

10. The substrate of claim 1 wherein the inclusion of the inorganic filler does not adversely affect the mechanical strength of the substrate.

11. A polymeric substrate comprising:
from about 30 to about 99 wt % low-density polyethylene;
from about 0 to about 40 wt % linear low-density polyethylene;
from about 1 to about 40 wt % of an inorganic filler; and
from about 0 to about 5 wt % of a pigment,
wherein the inclusion of the inorganic filler increases the oxygen transmission rate of the polymeric substrate.

12. The substrate of claim 11 wherein the inorganic filler is selected from the group consisting of inorganic carbonates, synthetic carbonates, nepheline syenite, talc, magnesium hydroxide, aluminum trihydrate, diatomaceous earth, mica, natural or synthetic silicas, calcined clays, and mixtures thereof.

13. The substrate of claim 11 wherein the inorganic filler is calcium carbonate.

14. The substrate of claim 11 wherein the inclusion of the inorganic filler decreases the water vapor transmission rate of the substrate.

15. The substrate of claim 11 wherein the inclusion of the inorganic filler increases the oxygen transmission rate of the substrate by at least about 10%.

16. The substrate of claim 11 wherein the inclusion of the inorganic filler decreases the water vapor transmission rate of the substrate by at least about 20%.

17. The substrate of claim 11 wherein the inclusion of the inorganic filler does not adversely affect the mechanical strength of the substrate.

18. A storage bag comprising a plastic film, the film comprising:
from about 30 to about 99 wt % low-density polyethylene;
from about 0 to about 40 wt % linear low-density polyethylene; and
from about 1 to about 40 wt % of an inorganic filler,
wherein the inclusion of the inorganic filler increases the oxygen transmission rate of the polymeric substrate.

19. The storage bag of claim 18 wherein the inorganic filler is calcium carbonate.

20. The storage bag of claim 19 wherein the bag further comprising a zipper the zipper comprising:
from about 55 to about 99 wt % of low-density polyethylene;
from about 1 to about 40 wt % of calcium carbonate; and
from about 0 to about 5 wt % of a pigment
